(19) United States
(12) Patent Application Publication
(10) Pub. No.: US 2026/0274290 A1
(43) Pub. Date: Sep. 17, 2026

(54) SERVER AND METHOD FOR CONTROLLING DRIVING OF A VEHICLE TO A TARGET LOCATION

(71) Applicants: Hyundai Motor Company, Seoul (KR); Kia Corporation, Seoul (KR)

(72) Inventor: Jin Hee LEE, Hwaseong-Si (KR)

(21) Appl. No.: 19/201,341

(22) Filed: May 7, 2025

(30) Foreign Application Priority Data
Oct. 23, 2024 (KR) 10-2024-0145948

(51) Int. Cl. B60W 60/00; G01C 21/00; G06F 3/04842; G06T 11/00

(52) U.S. Cl. CPC B60W 60/001; G01C 21/3811; G06F 3/04842; G06T 11/00

(57) ABSTRACT

An apparatus of a vehicle may comprise a communication circuit configured to communicate with a server, and a processor configured to display, via an interface, a target location image transmitted from the server. The processor may receive, via the interface, a user input, wherein the target location image is marked based on the user input to indicate a target location on the target location image, and wherein the target location is associated with a service requested by a terminal of a service requester. The processor may generate, based on the user input, a marked target location image and transmit the marked target location image to the server, enabling the server to share the marked target location image with the terminal of a service requester.

### CROSS-REFERENCE TO THE RELATED APPLICATION

The present application claims the benefit of priority under 35 U.S. C 119 from Korean Patent Application No. 10-2024-0145948, filed on Oct. 23, 2024 in the Korean Intellectual Property Office, the disclosure of which is incorporated herein by reference in its entirety.

### TECHNICAL FIELD

The present disclosure relates to controlling the driving of vehicle based on a target location identification technology. Specifically, it pertains to a server implemented to enable accurate communication of a target location between a vehicle and a target using an image, a method for controlling based on target location identification, and a vehicle configured for the same.

### BACKGROUND

The matters described as the background technology above are only for the purpose of enhancing understanding of the background of the present disclosure and should not be accepted as acknowledging that they correspond to prior art already known to those skilled in the art.

In order for target objects (e.g., people or loads) having the same destination or traveling in the same direction to use a same vehicle, there are cases where a vehicle may pick up different target objects (e.g., a furniture, an animal, a companion, etc.) from a common location (e.g., a target location).

In order for the vehicle to pick up a target, the vehicle and the target may communicate a target location, and the target may be picked up at the communicated target location.

If the target location is a location that both the vehicle and the target are familiar with, smooth pickup may be achieved.

However, if the target location is a location that only one of the vehicle and the target is familiar with, or a location that both the vehicle and the target are unfamiliar with, unnecessary time and effort may be consumed in picking up the target. In addition, stress and inconvenience may be caused to the vehicle and the target during the pickup process.

If an exact target location is not known or communicated between the vehicle and the target, the vehicle and the target may no longer attempt to use the vehicle due to unnecessary waste of time/effort, stress, inconvenience, etc., which may impede adoption and utilization of carpooling.

Thus, a method for a vehicle and a target to accurately communicate a target location is considered.

### SUMMARY

Therefore, the present disclosure has been made in view of the above problems, and it is an object of the present disclosure to provide a server configured such that a vehicle and a target may accurately communicate a target location, a target location identifying method thereof, and a vehicle therefor.

According to the present disclosure, an apparatus of a vehicle, the apparatus may comprise a communication circuit configured to communicate with a server, and a processor configured to, display, via an interface, a target location image transmitted from the server, receive, via the interface, a user input, wherein the target location image is marked based on the user input to indicate a target location on the target location image, and wherein the target location is associated with a service requested by a terminal of service requester, generate, based on the user input, a marked target location image, transmit the marked target location image to the server such that the server shares the marked target location image with the terminal of a service requester, output, based on the marked target location image, a signal, and control, based on the signal, driving of the vehicle to the target location.

The apparatus, wherein the processor is configured to receive a plurality of target location images from the server, and mark, based on the user input, a target location image selected from among the plurality of target location images.

The apparatus, wherein the processor is configured to, receive, from the server, a plurality of target location images captured in different directions at one point in time, and display, via the interface, the plurality of target location images.

The apparatus, wherein the processor is configured to, move, based on the user input, a mark displayed on the target location image, and generate, based on a user input indicating a selection completion after moving the mark, the marked target location image.

The apparatus, wherein the processor is configured to, based on receiving the marked target location image from the server, display via the interface, the marked target location image.

According to the present disclosure, a server configured to communicate with a vehicle, the server may comprise a communication circuit configured to communicate with a terminal and the vehicle, and a processor configured to, transmit a target location image to one of the terminal or the vehicle, wherein the target location image corresponds to target location information transmitted from the terminal, receive a marked target location image, wherein the marked target location image is transmitted from one of the terminal or the vehicle, whichever has received the target location image, transmit the marked target location image to the other of the terminal or the vehicle, output, based on the marked target location image, a signal, and cause the vehicle to control, based on the signal, driving of the vehicle.

The server, wherein the processor is configured to communicate, based on the target location information, with a neighboring vehicle via the communication circuit, and receive, based on the target location information, the pickup target location image from the neighboring vehicle.

The server wherein, based on absence of a neighboring vehicle or not receiving the target location image from the neighboring vehicle, the processor is configured to transmit a pre-stored road view image as the target location image.

The server, wherein the processor is configured to, based on the target location information and movement path information, communicate with the neighboring vehicle, wherein the neighboring vehicle is expected to pass a target location associated with the target location information, and wherein the movement path information is obtained from the neighboring vehicle.

The server, wherein the processor is configured to, based on the target location information and movement path information, communicate with a vehicle that has traveled past a target location associated with the target location information, wherein the movement path information is obtained from the neighboring vehicle.

The server, wherein the marked target location image may comprise a marked target location for indicating a target location.

The server, wherein the processor is configured to, transmit the target location image to the vehicle, and transmit the marked target location image transmitted from the vehicle to the terminal.

The server, wherein the processor is configured to, transmit the target location image to the terminal and transmit the marked target location image transmitted from the terminal to the vehicle.

The server, wherein the processor is configured to transmit a plurality of target location images to one of the terminal or the vehicle.

The server, wherein the processor is configured to transmit a plurality of target location images to one of the terminal or the vehicle, wherein the plurality of target location images are captured in different directions at one point in time.

According to the present disclosure, a method performed by a server configured to communicate with a vehicle, the method may comprise receiving, from a terminal, target location information, transmitting a target location image to one of the terminal or the vehicle, wherein the target location image corresponds to the target location information, receiving a marked target location image transmitted from one of the terminal or the vehicle, whichever has received the target location image, transmitting the marked target location image to the other of the terminal or the vehicle, outputting, based on the marked target location image, a signal, and causing, based on the signal, the vehicle to control driving of the vehicle.

The method may further comprise communicating, based on the target location information, with a neighboring vehicle, wherein the target location image is obtained, based on the target location information, from the neighboring vehicle.

The method, wherein the transmitting the target location image may comprise, based on absence of a neighboring vehicle or not receiving the target location image from the neighboring vehicle, transmitting a pre-stored road view image as the target location image.

The method may further comprise based on the target location information and movement path information, communicating with a neighboring vehicle, wherein the neighboring vehicle is expected to pass a target location associated with the target location information, and wherein the movement path information is obtained from the neighboring vehicle.

The method may further comprise based on the target location information and movement path information, communicating with a vehicle that has traveled past a target location associated with the target location information, wherein the movement path information is obtained from a neighboring vehicle.

Specific details according to various examples of the present disclosure other than the means for solving the problems mentioned above are included in the description and drawings below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an example of a configuration of a target location identifying system according to an example of the present disclosure;

FIG. 2 shows an example of a configuration of a server according to an example of the present disclosure;

FIG. 3 shows an example of a configuration of a vehicle terminal according to an example of the present disclosure;

FIG. 4 shows an example of a configuration of a requesting terminal according to an example of the present disclosure;

FIG. 5 shows an example of a configuration of a neighboring vehicle according to an example of the present disclosure;

FIG. 6 shows an example of a target location identifying method according to a first example of the present disclosure;

FIG. 7 shows an example of a target location identifying method according to a second example of the present disclosure;

FIG. 8 shows an example of a target location identifying method according to a third example of the present disclosure;

FIG. 9 shows an example of a screen where a target location information input window is displayed on the requesting terminal according to an example of the present disclosure;

FIG. 10 shows an example of a screen where multiple target location images are displayed on the vehicle terminal according to an example of the present disclosure;

FIG. 11 shows an example of a screen where a target location image is selected by a user; and

FIG. 12 shows another example of a screen displayed on the vehicle terminal according to an example of the present disclosure.

### DETAILED DESCRIPTION

In the following description of the examples disclosed in the present disclosure, a detailed description of known functions and configurations incorporated herein will be omitted when it may obscure the subject matter of the present disclosure. In addition, the accompanying drawings are provided only for ease of understanding of the examples disclosed in the present disclosure, do not limit the technical spirit disclosed herein, and include all changes, equivalents, and substitutes included in the spirit and scope of the present disclosure.

The terms “first” and/or “second” are used to describe various components, but such components are not limited by these terms. The terms are used to discriminate one component from another component.

An element described in the singular form is intended to include a plurality of elements unless the context clearly indicates otherwise.

In the present disclosure, it will be further understood that the term “comprise” or “include” specifies the presence of a stated feature, figure, step, operation, component, part, or combination thereof, but does not preclude the presence or addition of one or more other features, figures, steps, operations, components, or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The suffixes “module” and “unit” of elements used in the following description are used for convenience of description and thus can be used interchangeably and do not have any distinguishable meanings or functions.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

Hereinafter, examples disclosed in the present disclosure will be described in detail with reference to the attached drawings. However, identical or similar components will be assigned the same reference numeral, and redundant descriptions thereof will be omitted.

According to the present disclosure, the challenge of communicating pinpointing a clear target location is considered for controlling the driving of a vehicle (e.g., an autonomous driving vehicle) to the target location. When a user (e.g., a passenger or a driver) selects a desired target location, a system may retrieve the most recent images of that location from other vehicles that have recently driven past it. These images may be prioritized based on proximity and route relevance, ensuring accuracy and timeliness. The target location images may be then transmitted to the vehicle and reviewed/marked, via a user input, pinpointing a clear target location. By providing a visual reference (e.g., a flag, a pin, or a mark, etc.) on a target location image, the system may reduce the back-and-forth messages, which may be required to clarify a target location, improving overall efficiency and reducing confusion for controlling driving of the vehicle to the target location.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of a marked target location image) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of a marked target location image) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc. ) may also be controlled, for example, based on one or more features (e.g., feature of a marked target location image) described herein.

Minimum risk maneuver (MRM) operation(s) may also be controlled, for example, based on one or more features (e.g., feature of a marked target location image) described herein. A minimal risk maneuvering operation (e.g., a minimal risk maneuver, a minimum risk maneuver) may be a maneuvering operation of a vehicle to minimize (e.g., reduce) risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of a marked target location image) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of a marked target location image) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

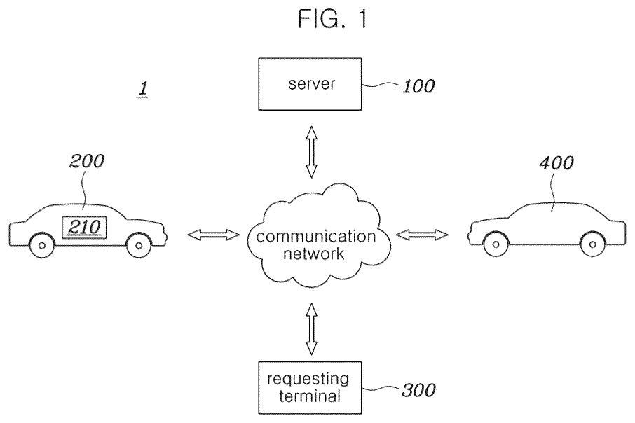

FIG. 1 shows an example of a configuration of a target location identifying system 1 according to an example of the present disclosure.

Referring to FIG. 1, the target location identifying system 1 according to an example of the present disclosure may include a server 100, a vehicle 200, a requesting terminal 300, and a neighboring vehicle 400, but the configuration of the target location identifying system 1 is not limited thereto.

In the example, the server 100 may be configured to provide a target location identification, and the vehicle 200 may be a vehicle used to pick up a target (or a requester).

In addition, the requesting terminal 300 is a terminal of a person who wants to use the target location identification (here, a target) and may be used to request the target location identification, and the neighboring vehicle 400 may be called by the server 100 and provide information requested by the server 100 to provide the target location identification.

In the example of the present disclosure, target location identification between a vehicle (e.g., based on an input to the vehicle by a driver or user of the vehicle, or a driver or user of a pickup vehicle) and a target, which is to be picked up by the vehicle, is performed. The target is picked up by the vehicle in a state in which the vehicle and the target are matched, as will be described.

For example, the server 100 may be a carpool providing server, the vehicle may be a carpool vehicle, and the target may be a person who has requested to use the vehicle or a load which is to be delivered by the vehicle.

The server 100, the vehicle 200, the requesting terminal 300, and the neighboring vehicle 400 may be selectively connected or linked through a network.

For example, wireless Internet technologies such as wireless LAN (WLAN), Wi-Fi, wireless broadband (WiBro), and/or World Interoperability for Microwave Access (WiMax), short-range communication technologies such as Bluetooth, Near Field Communication (NFC), Radio Frequency Identification (RFID), and/or Infrared Data Association (IrDA), and/or mobile communication technologies such as Code Division Multiple Access (CDMA), Global System for Mobile communication (GSM), Long Term Evolution (LTE), LTE-Advanced, and/or International Mobile Telecommunication (IMT)-2020 may be used as the network.

The server 100 according to the example may provide a target location identification indicating a common target location for the vehicle 200 and the requesting terminal 300.

The server 100 may manage registered vehicles and transmit and receive information while communicating with vehicles. For example, the server 100 may receive various types of information from vehicles, such as vehicle location/location-specific time information, images captured by the vehicles (captured images), image-specific capturing coordinates/capturing directions/capturing time, and navigation information (e.g., movement path, etc.).

According to an example, upon receiving target location information transmitted the requesting terminal 300, the server 100 may provide a target location image to the vehicle 200 or the requesting terminal 300 according to settings.

Here, the target location information may include coordinate information, address information, and the like of a target location, and may include information by which the server 100 may directly or indirectly identify the coordinates of a target location.

According to an example, the server 100 may communicate with the neighboring vehicle 400 based on target location information, receive a target location image transmitted from the called neighboring vehicle 400, and provide the received target location image to the vehicle 200 or the requesting terminal 300.

According to an example, communicating with the neighboring vehicle 400 by the server 100 may include selecting the neighboring vehicle 400 by the server 100 based on target location information, and requesting a target location image while transmitting the target location information to the selected neighboring vehicle 400 by the server 100.

For example, when the server 100 selects a neighboring vehicle 400, the server 100 may select a neighboring vehicle 400 that is expected to pass the target location based on movement path information of neighboring vehicles 400 adjacent to the target location.

According to an example, when the server 100 selects a neighboring vehicle 400, the server 100 may search for a vehicle that recently traveled past the target location based on previously stored movement path information, and select the matching neighboring vehicle 400.

For example, the server 100 may search for a vehicle that traveled in the rightmost lane at the target location based on previously stored movement path information. For example, if the server 100 fails to find a vehicle that traveled in the rightmost lane at the target location, the server 100 may search for a vehicle that traveled one lane to the left from the rightmost lane.

For example, if the road adjacent to the target location has three lanes, the server 100 may first search for a vehicle that traveled in the third lane at the target location, and if the server 100 fails to find a vehicle that traveled in the third lane, the server 100 may search for a vehicle that traveled in the second lane.

According to an example, if the server 100 fails to select a neighboring vehicle 400 or fails to receive a target location image from a neighboring vehicle 400, the server 100 may search for a load view image related to the target location among previously stored load view images and provide the matching load view image as a target location image to the vehicle 200 or the requesting terminal 300.

According to an example, the server 100 may obtain a load view image related to the target location from a linked load view image providing server, and provide the obtained load view image as a target location image to the vehicle 200 or the requesting terminal 300.

According to an example, the server 100 may receive a plurality of temporally sequential target location images and information on capturing coordinates/direction for each image from the neighboring vehicle 400. Here, the capturing direction may include information on whether the camera that has captured the image is a front camera, a rear camera, a left camera, or a right camera.

Accordingly, the server 100 may provide a plurality of sequential target location images and information on capturing coordinates/direction for each image to the vehicle 200 or the requesting terminal 300.

According to an example, the server 100 may receive an around view image related to a target location image from the neighboring vehicle 400. That is, the server 100 may receive a plurality of target location images captured in different directions at one point in time.

Accordingly, the server 100 may provide the around view image as a target location image to the vehicle 200 or the requesting terminal 300.

According to an example, the server 100 may transmit the target location image to the vehicle 200 or the requesting terminal 300, and then receive a target location indication image from the vehicle 200 or the requesting terminal 300.

Here, the target location indication image may mean a target location image in which a target location selected by the vehicle or the target (or a requester) is indicated (e.g., marked by a flag, a pin, etc.).

The server 100 may provide the target location indication image to the vehicle 200 or the requesting terminal 300.

For example, when the server 100 transmits the target location image to the vehicle 200, the server 100 may receive a target location indication image from the vehicle 200 and transmits the received target location indication image to the requesting terminal 300.

For example, when the server 100 transmits a target location image to the requesting terminal 300, the server 100 may receive a target location indication image from the requesting terminal 300 and transmit the received target location indication image to the vehicle 200.

According to an example, when the server 100 receives a target location indication image, the server 100 may determine the coordinates of the indicating means in the target location indication image, i.e., the coordinates of a designated target location.

According to an example, the server 100 may determine whether the vehicle 200 reaches the target location indicated by the target location indication means (e.g., a flag, a pin, a mark, etc.) based on the location information of the target location indicating means and the location information of the vehicle 200.

When the vehicle 200 reaches the target location, the server 100 may notify the vehicle 200 of the arrival at the target location and notify the requesting terminal 300 of the arrival of the vehicle.

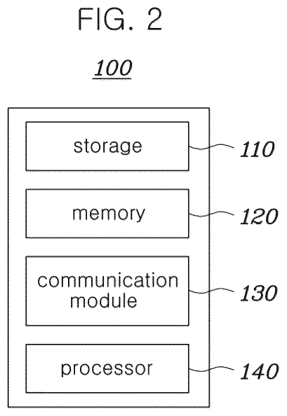

FIG. 2 shows an example of a configuration of the server 100 according to an example of the present disclosure.

Referring to FIG. 2, the server 100 may include a storage 110, a memory 120, a communication module 130, and a processor 140, but the configuration of the server 100 is not limited thereto.

The storage 110 may store information provided from vehicles managed by the server 100.

The memory 120 may store an algorithm (or a program or software), data, etc. for execution of the operation of the server 100.

For example, the storage 110 and the memory 120 may be implemented as at least one of storage media (or recording media) such as a flash memory, a hard disk, a secure digital (SD) card, a random access memory (RAM), a static random access memory (SRAM), a read only memory (ROM), a programmable read only memory (PROM) , an electrically erasable and programmable ROM (EEPROM), an erasable and programmable ROM (EPROM), a register, a removable disk, and web storage.

The communication module 130 may include a communication circuit configured to communicate with the vehicles 200 and 400 and the requesting terminal 300 through a network.

The processor 140 may perform the overall operation of the server 100 and may provide the target location identification by operating based on information stored in the storage 110, algorithms/data stored in the memory 120, etc.

The processor 140 may be a data processing device implemented as hardware having a circuit having a physical structure for executing desired operations. For example, the desired operations may include code or instructions included in a program.

For example, the data processing device implemented as hardware may include a microprocessor, central processing unit, a processor core, a multi-core processor, a multiprocessor, an application-specific integrated circuit (ASIC), and a field programmable gate array (FPGA).

The vehicle 200 according to the example may communicate with the server 100 through a network and use the target location identification provided by the server 100.

For example, the vehicle 200 may be registered with the server 100 in order to use the target location identification and may be managed by the server 100. For example, the vehicle 200 may transmit vehicle location information, location-specific time information, captured images, and captured time information for each image to the server 100.

The vehicle 200 may include a vehicle terminal (vehicle terminal) 210 configured to use the target location identification, and the vehicle terminal 210 may be implemented as an AVNT (Audio/Video/Navigation/Telematics) system, a head unit, or the like.

The vehicle terminal 210 may receive a target location image transmitted from the server 100, generate a target location indication image in which a target location indicating means is displayed by the user, and transmit the generated target location indication image to the server 100.

The vehicle terminal 210 may display the target location image transmitted from the server 100, display the target location indication means on the displayed target location image, and move the position of the target location indicating means (e.g. a flag, a pin, mark, etc.) according to an instruction of the user.

For example, the vehicle terminal 210 may display a selection completion button in the form of a graphical user interface (GUI) and generate a target location indication image if the selection completion button is selected or clicked.

According to an example, the vehicle terminal 210 may receive a plurality of target location images from the server 100, display the received plurality of target location images, and enlarge and display a target location image selected by the user from among the plurality of displayed target location images.

Accordingly, the vehicle terminal 210 may display the target location indicating means (e.g., a flag, a pin, a mark, etc.) on a target location image selected from among the plurality of target location images, and move the position of the target location indicating means according to an instruction of the user received via a user interface.

According to an example, the vehicle terminal 210 may receive, from the server 100, a target location image, and capturing coordinate information and capturing direction information for the image.

Accordingly, the vehicle terminal 210 may simultaneously display the target location image and a navigation road image, and display the capturing coordinates for the target location image on the navigation road image.

For example, the vehicle terminal 210 may display a vehicle image at a location corresponding to the capturing coordinates. For example, the vehicle terminal 210 may display a capturing direction on the navigation road image along with the vehicle image.

According to an example, the vehicle terminal 210 may receive an around view image related to a target location image from the server 100 and display the around view image.

The vehicle terminal 210 may transmit a target location indication image to the server 100 according to an instruction of the user received via a user interface.

For example, the vehicle terminal 210 may display a transmission button in the form of a GUI, and provide the target location indication image to the server 100 if the transmission button is selected or clicked.

According to an example, the vehicle terminal 210 may receive a target location indication image from the server 100 and display the target location indication image. For example, the vehicle terminal 210 may display the target location indication image on the navigation.

According to an example, the vehicle terminal 210 may receive a target location arrival notification from the server 100. For example, upon receiving the target location arrival notification, the vehicle terminal 210 may display target location arrival, display the target location through the navigation, and display a target location indication image.

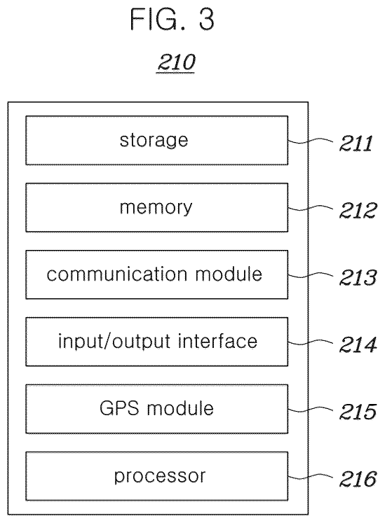

FIG. 3 shows an example of a configuration of the vehicle terminal 210 according to an example of the present disclosure.

Referring to FIG. 3, the vehicle terminal 210 may include a storage 211, a memory 212, a communication module 213, an input/output interface 214, a GPS module 215, and a processor 216, but the configuration of the vehicle terminal 210 is not limited thereto.

The storage 211 may store information acquired by the vehicle terminal 210 and store information necessary for the operation of the vehicle terminal 210.

The memory 212 may store an algorithm (or a program or software), data, etc. for execution of the operation of the vehicle terminal 210.

For example, the storage 211 and the memory 212 may be implemented as at least one of storage media (or recording media) such as a flash memory, a hard disk, a secure digital (SD) card, a random access memory (RAM), a static random access memory (SRAM), a read only memory (ROM), a programmable read only memory (PROM) , an electrically erasable and programmable ROM (EEPROM), an erasable and programmable ROM (EPROM), register, a removable disk, and web storage.

The communication module 213 may include a communication circuit configured to communicate with the server 100 through a network. According to an example, the communication module 213 may be configured to receive navigation map information through a network.

The input/output interface 214 may be configured to display various types of information for s provided by the vehicle terminal 210.

For example, the input/output interface 214 may display information provided from the server 100. For example, the input/output interface 214 may display various types of information for providing the target location identification.

The input/output interface 214 may be configured to receive instructions from the user. For example, the input/output interface 214 may receive an instruction from the user through a displayed image.

The GPS (Global Positioning System) module 215 may be configured to receive a GPS satellite signal. For example, the GPS module 215 may include a GPS receiving antenna and a reception device.

According to an example, the GPS module 215 may recognize the location of the vehicle 200 based on GPS satellite signals.

The processor 216 may perform the overall operation of the vehicle terminal 210 and control other components within the vehicle terminal 210.

According to an example, the processor 216 may operate based on information stored in the storage 211, algorithms/data stored in the memory 212, etc.

For example, the processor 216 may be a data processing device implemented as hardware having a circuit having a physical structure for executing desired operations. For example, the desired operations may include code or instructions included in a program.

For example, the data processing device implemented in hardware may include a microprocessor, a central processing unit, a processor core, a multi-core processor, a multiprocessor, an application-specific integrated circuit (ASIC), and a field programmable gate array (FPGA).

The requesting terminal 300 according to the example may communicate with the server 100 through a network and may be operated by a user (a target or a requester) who requests the target location identification.

The requesting terminal 300 may be registered with the server 100 and may use the target location identification provided by the server 100.

The requesting terminal 300 may be equipped with an application for the target location identification and may use the target location identification according to execution of the application for the target location identification.

As the application for the target location identification is executed, the requesting terminal 300 may be linked with the server 100 and may transmit and receive information through a network.

According to the example, the requesting terminal 300 may display a target location input screen and provide target location information input through the target location input screen to the server 100.

For example, the target location input screen may be implemented such that a road name address may be input thereto. For example, the target location input screen may be implemented to display a map image around the input road name address and receive a location selected from the displayed map image. For example, the target location input screen may be implemented to receive caution information (e.g., warnings or special notes related to the target location that the vehicle should be aware of, for example, “Use the side entrance,” “Watch out for heavy traffic,” or “Avoid no-parking zones,” etc.) and requests.

According to the example, the requesting terminal 300 may display a target location image provided from the server 100, display a target location indicating means on the displayed target location image, and move the position of the target location indicating means (e.g., a flag, a pin, a mark, etc.) according to an instruction of the user.

The requesting terminal 300 may provide the target location image on which the target location indicating means is displayed (“target location indication image”) to the server 100 according to an instruction of the user.

For example, the requesting terminal 300 may display a transmission button in the form of a GUI, and provide the target location indication image to the server 100 if the transmission button is selected or clicked.

According to an example, the requesting terminal 300 may receive a target location indication image from the server 100 and display the target location indication image.

According to an example, the requesting terminal 300 may receive a vehicle arrival notification from the server 100. For example, when the requesting terminal 300 receives the vehicle arrival notification, the requesting terminal 300 may display a target location indication image. For example, the requesting terminal 300 may display a map showing the target location and the target location indication image together.

If the requesting terminal 300 provides the map showing the target location and the target location indication image together in this manner, the user may recognize the target location more intuitively and accurately.

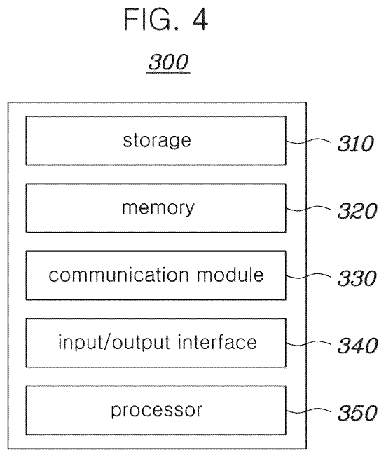

FIG. 4 shows an example of a configuration of the requesting terminal 300 according to an example of the present disclosure.

Referring to FIG. 4, the requesting terminal 300 may include a storage 310, a memory 320, a communication module 330, an input/output interface 340, and a processor 350, but the configuration of the request terminal 300 is not limited thereto.

The storage 310 may store information necessary for the operation of the requesting terminal 300, information acquired by the requesting terminal 300, an application programmed to enable the requesting terminal 300 to use the target location identification, and the like.

The memory 320 may store an algorithm (or a program or software), data, etc. for execution of the operation of the requesting terminal 300. According to an example, a target location identifying application may be executed using the memory 320.

For example, the storage 310 and the memory 320 may be implemented as at least one of storage media (or recording media) of a flash memory, a hard disk, an SD card, a RAM, an SRAM, a ROM, a PROM, an EEPROM, an EPROM, a register, a removable disk, and web storage.

The communication module 330 may include a communication circuit configured to communicate with the server 100 through a network. According to an example, the communication module 330 may be linked with the server 100 to transmit and receive information for the target location identification.

The input/output interface 340 may be configured to display various types of information for the target location identification provided by the requesting terminal 300.

For example, the input/output interface 340 may display information provided from the server 100. For example, the input/output interface 340 may display various types of information for providing the target location identification. For example, the input/output interface 340 may display various types of information for providing the target location identification.

The input/output interface 340 may be configured to receive instructions from the user. For example, the input/output interface 340 may receive an instruction from the user through a displayed image.

The processor 350 may perform the overall operation of the requesting terminal 300 and control other components within the requesting terminal 300.

According to an example, the processor 350 may operate based on information stored in the storage 310, algorithms/data stored in the memory 320, and the like. For example, the processor 350 may be a data processing device implemented as hardware having a circuit having a physical structure for executing desired operations. For example, the desired operations may include code or instructions included in a program.

For example, the data processing device implemented as hardware may include a microprocessor, central processing unit, a processor core, a multi-core processor, a multiprocessor, an ASIC, or an FPGA.

The neighboring vehicle 400 according to the example communicates with the server 100 through a network and may be called by the server 100. Here, the neighboring vehicle 400 may be a vehicle that has been registered with the server 100 and is managed by the server 100.

According to the example, the neighboring vehicle 400 may be a vehicle that is scheduled to pass a target location corresponding to a target location image that the server 100 intends to acquire.

The neighboring vehicle 400 may receive target location information transmitted from the server 100 and transmit a captured image acquired while passing by the target location to the server 100. Here, the captured image may correspond to a target location image.

According to an example, if the neighboring vehicle 400 cannot acquire a captured image, the neighboring vehicle 400 may transmit an image failure message to the server 100.

For example, cases in which a captured image cannot be acquired may include cases in which an image-capturing means is not provided in the neighboring vehicle 400, cases in which an image-capturing means is provided in the neighboring vehicle 400 but does not operate, cases in which an image-capturing means is provided in the neighboring vehicle 400 but does not operate normally, and the like.

According to an example, the neighboring vehicle 400 may provide temporally sequential captured images to the server 100. For example, the neighboring vehicle 400 may provide image-capturing coordinate/direction information for each image along with captured images.

According to an example, the neighboring vehicle 400 may capture an around view image and provide the around view image to the neighboring vehicle 400. For example, the neighboring vehicle 400 may provide image-capturing coordinate/direction information for each image along with the around view image.

According to an example, the neighboring vehicle 400 may be a vehicle that has passed a target location corresponding to a target location image that the server 100 intends to acquire.

The neighboring vehicle 400 may receive target location information provided from the server 100, search for a captured image corresponding to the target location information based on previously stored captured images and image-capture coordinates, and provide the matching captured image to the server 100. Here, the captured image may correspond to a target location image.

According to an example, if the neighboring vehicle 400 fails to find a captured image corresponding to the target location information, the neighboring vehicle 400 may transmit an image failure message to the server 100.

According to an example, the neighboring vehicle 400 may provide temporally sequential captured images to the server 100. For example, the neighboring vehicle 400 may provide image-capture coordinate/direction information for each image along with captured images.

According to an example, the neighboring vehicle 400 may provide an around view image to the neighboring vehicle 400. For example, the neighboring vehicle 400 may provide image-capture coordinate/direction for each image along with the around view image.

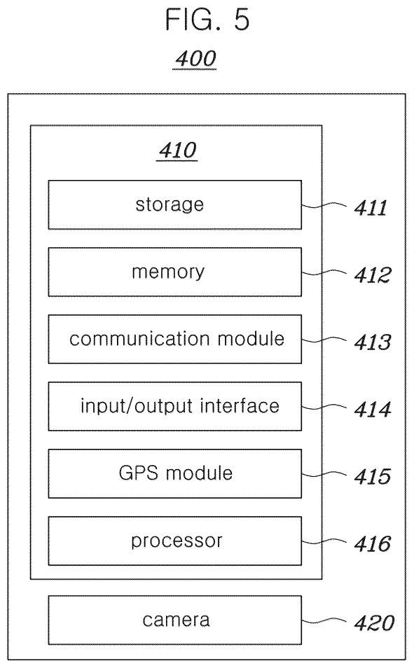

FIG. 5 shows an example of a configuration of the neighboring vehicle 400 according to an example of the present disclosure.

Referring to FIG. 5, the neighboring vehicle 400 may include a vehicle terminal (neighboring vehicle terminal) 410 and a camera 420. The vehicle terminal 410 may communicate with the server 100 through a network and provide a captured image to the server 100 according to a request of the server 100.

The camera 420 may obtain a captured image for an image-capture area set based on a viewing angle. For example, the camera 420 may store captured images in a linked storage device. For example, the camera 420 may store captured images along with image-capture coordinate/direction information. According to an example, one or a plurality of cameras 420 may be provided.

According to an example, the vehicle terminal 410 and the camera 420 may be linked. For example, the vehicle terminal 410 and the camera 420 may share a storage device. The vehicle terminal 410 and the camera 420 may include separate storage devices. For example, the vehicle terminal 410 may control the operation of the camera 420 and collect the status of the camera 420.

For example, the vehicle terminal 410 may be implemented as an AVNT (Audio/Video/Navigation/Telematics) system, a head unit, or the like.

The vehicle terminal 410 may include a storage 411, a memory 412, a communication module 413, an input/output interface 414, a GPS module 415, and a processor 416, but the configuration of the vehicle terminal 410 is not limited thereto.

The storage 411 may store information acquired by the vehicle terminal 410 and information necessary for the operation of the vehicle terminal 410. According to an example, a captured image acquired by the camera 420 may be stored in the storage 411.

The memory 412 may store an algorithm (or a program or software), data, etc. for execution of the operation of the vehicle terminal 410.

For example, the storage 411 and the memory 412 may be implemented as at least one of storage media (or recording media) such as a flash memory, a hard disk, an SD card, a RAM, an SRAM, a ROM, a PROM, an EEPROM, an EPROM, a register, a removable disk, and web storage.

The communication module 413 may include a communication circuit configured to communicate with the server 100 through a network.

The input/output interface 414 may be configured to display various types of information for functions provided by the vehicle terminal 410 and may be implemented to receive instructions from the user.

The GPS module 415 may be configured to receive GPS satellite signals. For example, the GPS module 415 may include a GPS receiving antenna and a reception device.

According to an example, the GPS module 415 may recognize the location of a neighboring vehicle 400 based on GPS satellite signals.

The processor 416 may perform the overall operation of the vehicle terminal 410 and control other components within the vehicle terminal 410.

According to an example, the processor 416 may operate based on information stored in the storage 411, algorithms/data stored in the memory 412, etc.

For example, the processor 416 may be a data processing device implemented as hardware having a circuit having a physical structure for executing desired operations. For example, the desired operations may include code or instructions included in a program.

For example, the data processing device implemented as hardware may include a microprocessor, a central processing unit, a processor core, a multi-core processor, a multiprocessor, an ASIC, and an FPGA.

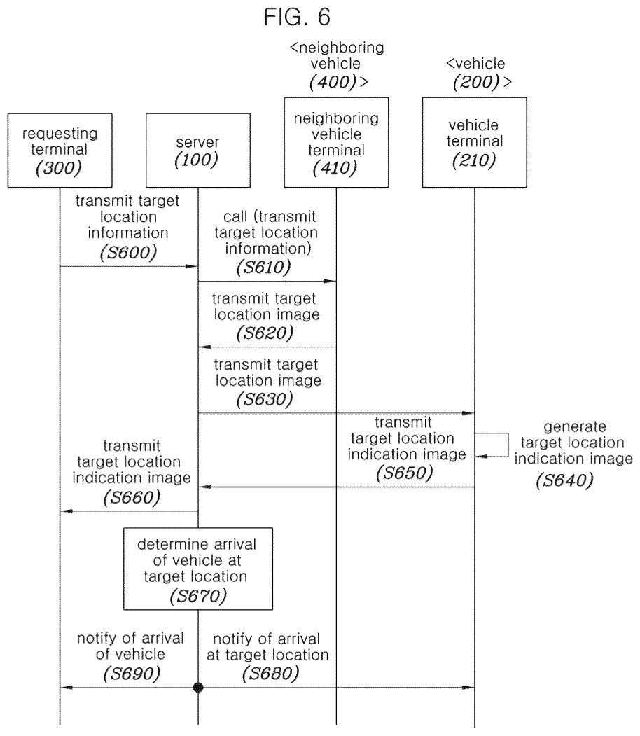

FIG. 6 shows an example of a method of providing a target location identification according to a first example of the present disclosure.

FIG. 6 shows a case in which the server 100 receives a target location image from the called neighboring vehicle 400 and provides the target location image to the vehicle 200.

Referring to FIG. 1 to FIG. 6, the requesting terminal 300 may transmit target location information to the server 100 (S600).

The server 100 may call the neighboring vehicle 400 based on the target location information in order to receive a target location image (S610).

In step S610, the server 100 may transmit the target location information to the neighboring vehicle 400.

According to an example, the server 100 may call a neighboring vehicle 400 that is expected to pass the target location based on movement path information obtained from the neighboring vehicle 400.

According to an example, the server 100 may call a neighboring vehicle 400 that recently traveled past the target location based on movement path information obtained from the neighboring vehicle 400.

Thereafter, the vehicle terminal (neighboring vehicle terminal) 410 of the neighboring vehicle 400 called by the server 100 may transmit a target location image to the server 100 (S620).

According to an example, if the neighboring vehicle 400 called by the server 100 is a neighboring vehicle 400 that is expected to pass the target location, the neighboring vehicle terminal 410 may transmit a target location image acquired by the camera 420 while passing the target location to the server 100.

According to an example, if the neighboring vehicle 400 called by the server 100 is a neighboring vehicle 400 that has traveled past the target location, the neighboring vehicle terminal 410 may transmit a target location image captured at the target location among previously stored captured images to the server 100.

Thereafter, the server 100 may transmit the target location image to the vehicle 200 (S630).

Thereafter, the vehicle terminal (vehicle terminal) 210 of the vehicle 200 may generate a target location indication image in which a target location indicating means is displayed by the user (S640).

In step S640, the vehicle terminal 210 may display the target location image provided from the server 100 on the input/output interface 214, display the target location indicating means on the displayed target location image, and move the position of the target location indicating means according to an instruction of the user.

In step S640, the vehicle terminal 210 may display a selection completion button in the form of a GUI, and if the selection completion button is selected or clicked, generate a target location indication image.

Thereafter, the vehicle terminal 210 may transmit the target location indication image to the server 100 according to an instruction of the user (S650).

For example, the vehicle terminal 210 may display a transmission button in the form of a GUI, and if the transmission button is selected or clicked, provide the target location indication image to the server 100.

Thereafter, the server 100 may transmit the target location indication image to the requesting terminal 300 (S660).

Thereafter, upon determining that the vehicle 200 has reached the target location indicated by the target location indicating means based on location information of the target location indicating means and the location information of the vehicle 200 (S670), the server 100 may notify the vehicle 200 of arrival at the target location (S680), and notify the requesting terminal 300 of arrival of the vehicle (S690).

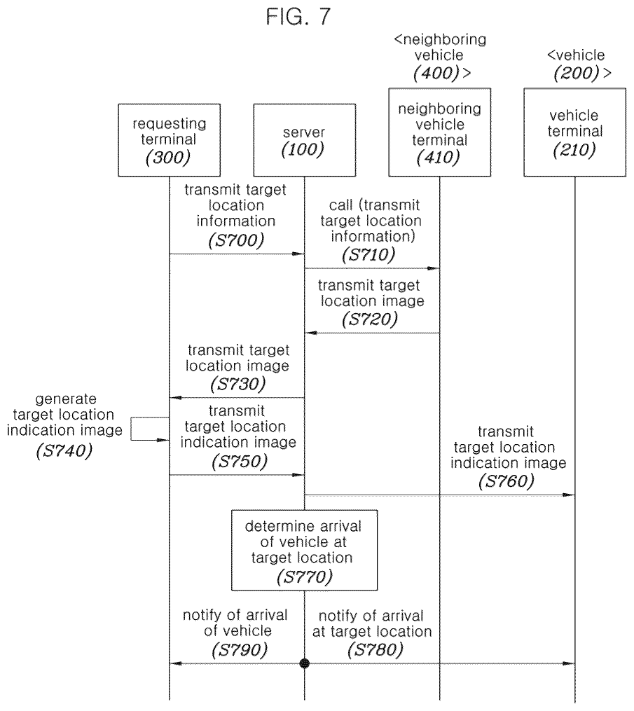

FIG. 7 shows an example of a method of providing a target location identification according to a second example of the present disclosure.

FIG. 7 shows a case in which the server 100 receives a target location image from a called neighboring vehicle 400 and provides the target location image to the requesting terminal 300.

The target location identifying method according to the second example is different from the target location identifying method according to the first example in that the server 100 provides a target location image to the requesting terminal 300.

Hereinafter, the target location identifying method according to the second example will be described with reference to FIG. 7, and the same operations as the target location identifying method according to the first example will be briefly described or omitted.

Referring to FIG. 1 to FIG. 5 and FIG. 7, the operations performed in steps S700 to S720 may be the same as the operations performed in steps S600 to S620 of FIG. 6.

In step S730, the server 100 may transmit a target location image to the requesting terminal 300.

Thereafter, the requesting terminal 300 may generate a target location indication image on which a target location indicating means is displayed by the user (S740).

In step S740, the requesting terminal 300 may display the target location image provided from the server 100 on the input/output interface 340, display the target location indicating means on the displayed target location image, and move the position of the target location indicating means according to an instruction of the user.

In step S740, the requesting terminal 300 may display a selection completion button in the form of a GUI, and if the selection completion button is selected or clicked, generate a target location indication image.

Thereafter, the requesting terminal 300 may transmit the target location indication image to the server 100 according to an instruction of the user (S750).

For example, the requesting terminal 300 may display a transmission button in the form of a GUI, and if the transmission button is selected or clicked, provide the target location indication image to the server 100.

Thereafter, the server 100 may transmit the target location indication image to the vehicle 200 (S760).

Thereafter, upon determining that the vehicle 200 has reached the target location based on the target location indication image and the location information of the vehicle 200 (S770), the server 100 may notify the vehicle 200 of the arrival at the target location (S780) and notify the requesting terminal 300 of the arrival of the vehicle (S790).

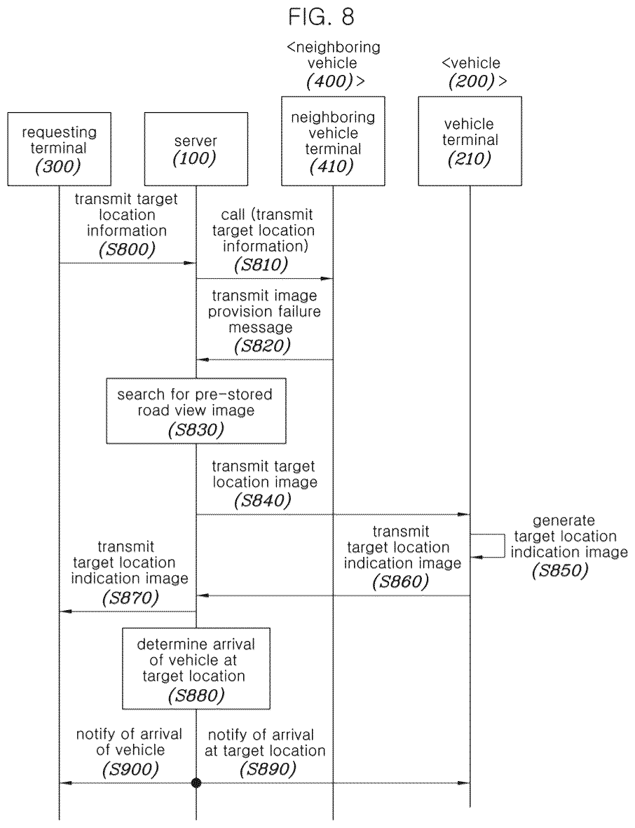

FIG. 8 shows an example of a method of providing a target location identification according to a third example of the present disclosure.

FIG. 8 shows a case in which the server 100 fails to call the neighboring vehicle 400 or fails to receive a target location image from the called neighboring vehicle 400 and provides a pre-stored road view image as a target location image to the vehicle 200.

Although FIG. 8 shows a case in which the server 100 fails to receive a target location image from the neighboring vehicle 400, the method shown in FIG. 8 may also be applied to a case in which the server 100 fails to call a neighboring vehicle 400.

The target location identifying method according to the third example differs from the target location identifying method according to the first example in that the server 100 provides a pre-stored road view image as a target location image to the vehicle 200.

Hereinafter, the target location identifying method according to the third example will be described with reference to FIG. 8, but the same operations as the target location identifying method according to the first example will be briefly described or omitted.

Referring to FIG. 1 to 5 and FIG. 8, the operations performed in steps S800 and S810 may be the same as the operations performed in steps S600 and S610 of FIG. 6.

After step S810, if the neighboring vehicle terminal 410 fails to transmit a target location image corresponding to the target location, it may transmit an image failure message to the server 100 (S820).

According to an example, if the neighboring vehicle 400 called by the server 100 is a neighboring vehicle 400 expected to pass the target location, the neighboring vehicle 400 may not travel the target location contrary to expectation of the server 100, and if the neighboring vehicle 400 does not travel the target location, the neighboring vehicle terminal 410 may transmit the image failure message to the server 100.

According to an example, when the neighboring vehicle 400 called by the server 100 is a neighboring vehicle 400 that has traveled past the target location, the neighboring vehicle terminal 410 may transmit the image failure message to the server 100 if it fails to find a target location image obtained by capturing the target location among pre-stored captured images.

Upon receiving the image failure message from the neighboring vehicle 400, the server 100 may search for a pre-stored road view image (S830) and transmit the matching road view image as a target location image to the vehicle 200 (S840).

Steps S850 to S900 performed after step S840 may be identical to steps S640 to S690 of FIG. 6, and thus a detailed description thereof will be omitted.

Meanwhile, the target location identifying method according to the third example of the present disclosure may be equally applied to a case in which a target location image is provided to the requesting terminal 300.

That is, after step S830, the server 100 may provide the matching road view image as a target location image to the requesting terminal 300, and accordingly, steps S740 to S790 may be performed.

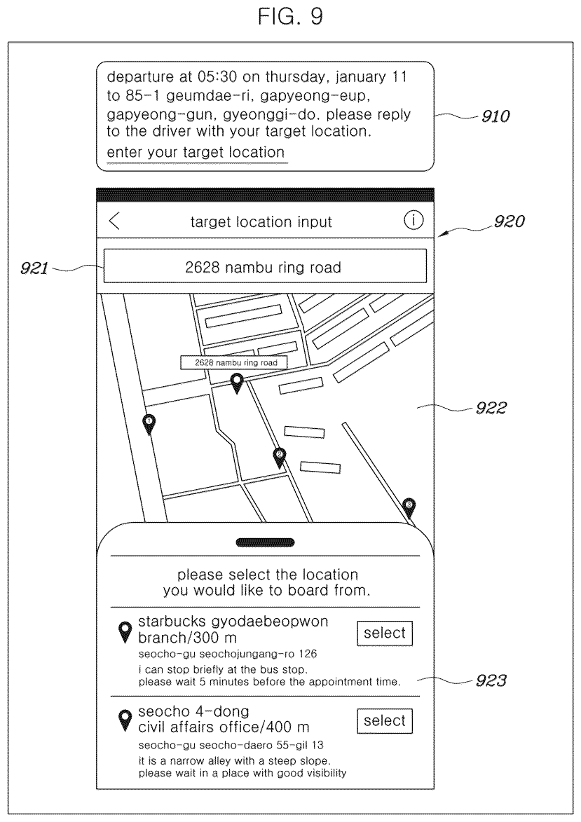

FIG. 9 shows an example of a screen where a target location information input window is displayed on the requesting terminal 300 according to an example of the present disclosure.

As shown in FIG. 9, the requesting terminal 300 may display a guidance window 910 for guiding input of a target location, and a target location input window 920 configured such that a target location is input thereto.

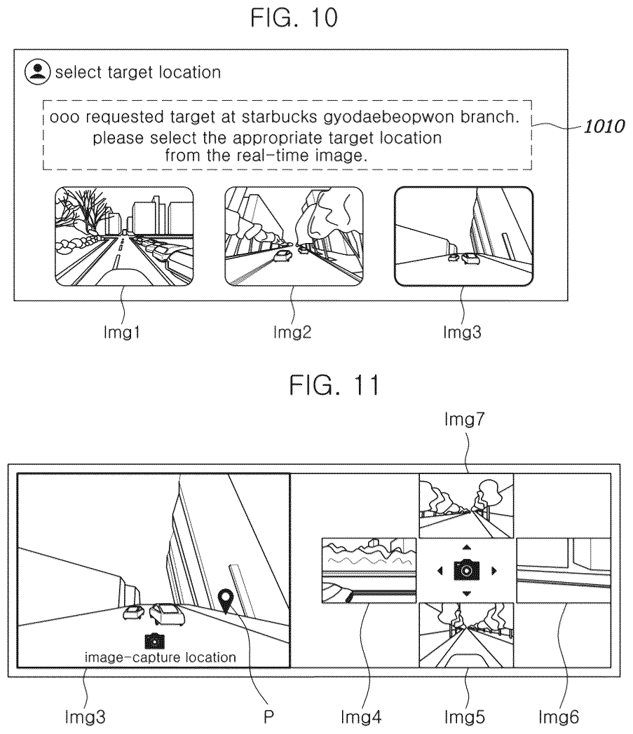

For example, the guidance window 910 may display guidance text, and the target location input window 920 may display an address input window 921, a map 922 related to an address input in the address input window 921, and a selection window 923 configured such that a major location within the map may be selected, but is not limited thereto. FIG. 10 shows an example of a screen where multiple target location images are displayed on the vehicle terminal 210 according to an example of the present disclosure, and FIG. 11 shows an example of a screen where a target location image is selected by a user.

As shown in FIG. 10, the vehicle terminal 210 may display guidance text 1010 and multiple target location images Img1, Img2, and Img3.

In FIG. 10, if the target location image Img3 is selected, the vehicle terminal 210 may enlarge and display the selected target location image Img3, as shown in FIG. 11, and display a target location indicating means P on the selected target location image Img3.

In addition, the vehicle terminal 210 may display captured images Img4 to Img7 of an image-capture point in various directions related to the selected target location image Img3.

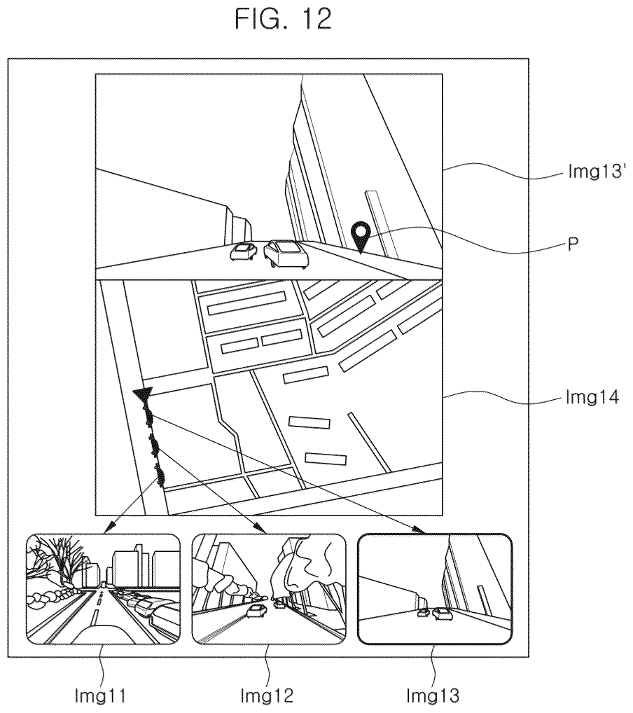

FIG. 12 shows another example of a screen displayed on the vehicle terminal 210 according to an example of the present disclosure.

Referring to FIG. 12, a plurality of target location images Img11, Img12, and Img13, an image-capture information image Img14 for each target location image, and an enlarged image Img13′ of a target location image Img13 selected by a user may be displayed on one screen.

For example, the image-capture information image Img14 may display an image-capture point/direction for each target location image. For example, the image-capture information may be displayed by a vehicle image (indicating an image-capture point) and a viewing angle (indicating an image-capture direction).

As shown in FIG. 12, a target location indicating means P may be displayed on the enlarged image Img13′ of the target location image Img13 selected from among the plurality of target location images Img11, Img12, and Img13. The user may display an accurate target location by moving the target location indicating means P.

It is an object of examples of the present disclosure to provide a server configured such that a vehicle and a target may accurately determine a target location based on an image, a target location identifying method thereof, and a vehicle therefor.

It is an object of the examples of the present disclosure to provide a server configured to be able to provide a latest image related to a target location such that an accurate target location may be communicated between a vehicle and a target, a target location identifying method thereof, and a vehicle therefor.

It is an object of the examples of the present disclosure to provide a server configured to be able to provide road view images such that a vehicle and a target may accurately designate and communicate a target location, a target location identifying method thereof, and a vehicle therefor.

It is an object of the examples of the present disclosure to provide a server configured to be able to display a target location indicating means (e.g., a flag, a pin, a mark, etc.) on a road view image such that a vehicle or a target may accurately designate and communicate a target location, a target location identifying method thereof, and a vehicle therefor.

It is an object of the examples of the present disclosure to provide a target location identification providing server that may be used for a carpool, a target location identifying method thereof, and a vehicle therefor.

The technical objects to be achieved in the present disclosure are not limited to the technical objects mentioned above, and other technical objects that are not mentioned can be clearly understood by those skilled in the art to which the present disclosure belongs from the description below.

In accordance with an example of the present disclosure, the above and other objects may be accomplished by a vehicle including a vehicle terminal linked to a server providing a target location identification, wherein the vehicle terminal includes a communication circuit configured to communicate with the server, and a processor configured to display a target location image on an interface (e.g., an input/output interface) upon receiving the target location image transmitted from the server, display a target location indicating means (e.g., a flag, a pin, a mark, etc.) on the displayed target location image according to an instruction of a user to generate a target location indication image, and transmit the target location indication image to the server such that the server communicates the target location indication image (e.g., a marked target location image) with a terminal of a requester.

According to an example of the present disclosure, the processor may receive a plurality of (e.g., temporally sequential) target location images from the server, and display the target location indicating means (e.g., a flag, a pin, a mark, etc.) on a target location image selected from among the plurality of target location images according to an instruction of the user.

According to an example of the present disclosure, the processor may receive a plurality of target location images captured in different directions at one point in time from the server, and display the plurality of target location images on the input/output interface.

According to an example of the present disclosure, the processor may move the target location indicating means (e.g., a flag, a pin, a mark, etc.) displayed on the target location image according to an instruction of the user, and generate the target location indication image (e.g., a marked target location image) in response that the user inputs a selection completion instruction.

In accordance with another example of the present disclosure, there is provided a server providing a target location identification, the server including a communication circuit configured to communicate with a requesting terminal and a vehicle, and a processor configured to transmit a target location image corresponding to target location information transmitted from the requesting terminal to one of the requesting terminal or the vehicle, receive a target location indication image transmitted from one of the requesting terminal or the vehicle, whichever has received the target location image, and transmit the target location indication image to the other of the requesting terminal and the vehicle (e.g., whichever has not received the target location image).

According to an example of the present disclosure, the processor may call a neighboring vehicle based on the target location information, and receive the target location image from the called neighboring vehicle.

According to an example of the present disclosure, if there is no neighboring vehicle to be called or the processor does not receive the target location image from the called neighboring vehicle, the processor may transmit a pre-stored road view image as the target location image.

According to an example of the present disclosure, the processor may call a neighboring vehicle expected to pass the target location based on the target location information and movement path information collected or obtained with respect to the neighboring vehicle.

According to an example of the present disclosure, the processor may call a vehicle that has traveled past the target location based on the target location information and movement path information collected or obtained with respect to the neighboring vehicle.

According to an example of the present disclosure, the target location indication image may include a target location indicating means (e.g., a flag, a pin, a mark, etc.) for indicating a target location.

According to an example of the present disclosure, the processor may transmit the target location image to the vehicle and transmit the target location indication image (e.g., a marked target location image) transmitted from the vehicle to the requesting terminal.

According to an example of the present disclosure, the processor may transmit the target location image to the requesting terminal and transmit the target location indication image (e.g., a marked target location image) transmitted from the requesting terminal to the vehicle.

According to an example of the present disclosure, the processor may transmit a plurality of (e.g., temporally sequential) target location images to one of the requesting terminal or the vehicle.

According to an example of the present disclosure, the processor may transmit a plurality of target location images captured in different directions at one point in time to one of the requesting terminal or the vehicle.

In accordance with a further example of the present disclosure, there is provided a method of providing a target location identification, the method including receiving, by a server, target location information transmitted by a requesting terminal, transmitting, by the server, a target location image corresponding to the target location information to one of the requesting terminal or a vehicle, receiving, by the server, a target location indication image (e.g., a marked target location image) transmitted from one of the requesting terminal or the vehicle, whichever has received the target location image, and transmitting, by the server, the target location indication image to the other of the requesting terminal and the vehicle (e.g., whichever has not received the target location image).

According to an example of the present disclosure, the transmitting, by the server, a target location image to one of the requesting terminal or a vehicle may include calling a neighboring vehicle based on the target location information and transmitting the target location image provided from the called neighboring vehicle to one of the requesting terminal or the vehicle by the server.

According to an example of the present disclosure, the transmitting, by the server, a target location image to one of the requesting terminal or a vehicle may include transmitting a pre-stored road view image as the target location image by the server if there is no neighboring vehicle to be called or the target location image is not provided from the neighboring vehicle.

According to an example of the present disclosure, the calling a neighboring vehicle may include calling, by the server, a neighboring vehicle expected to pass the target location based on target location information and movement path information obtained with respect to the neighboring vehicle.

According to an example of the present disclosure, the calling a neighboring vehicle may include calling, by the server, a vehicle that has traveled past the target location based on the target location information and the movement path information obtained from the neighboring vehicle.

According to example of the present disclosure, it is possible to provide a server configured such that a vehicle and a target may accurately determine a target location based on an image, a target location identifying method thereof, and a vehicle therefor.

According to the example of the present disclosure, it is possible to provide a server configured to be able to provide a latest image related to a target location such that an accurate target location may be communicated between a vehicle and a target, a target location identifying method thereof, and a vehicle therefor.

According to the example of the present disclosure, it is possible to provide a server configured to be able to provide road view images such that a vehicle and a target may accurately designate and communicate a target location, a target location identifying method thereof, and a vehicle therefor.

According to the example of the present disclosure, it is possible to provide a server configured to be able to display a target location indicating means (e.g., a flag, a pin, etc.) on a road view image according to an instruction of a vehicle or a target, a target location identifying method thereof, and a vehicle therefor.

By using the target location identification according to the examples of the present disclosure, a vehicle and a target may accurately communicate a target location. Therefore, the time and effort required to pick up the target may be reduced.

In addition, since the target process is carried out smoothly, the stress and inconvenience caused by the target process may be alleviated.

By using the target location identification according to the examples of the present disclosure for the carpool, it is possible to induce the settlement and activation of carpool and aid in reducing social costs and traffic congestion, etc.

The effects obtained from the present disclosure are not limited to the effects mentioned above, and other effects not mentioned can be clearly understood by those skilled in the art to which the present disclosure belongs from the description below.

Although the examples of the present disclosure have been described in more detail with reference to the attached drawings, the present disclosure is not necessarily limited to these examples, and various modifications may be made without departing from the technical idea of the present disclosure. Accordingly, the examples disclosed in this specification are not intended to limit the technical idea of the present disclosure, but to explain the same, and the scope of the technical idea of the present disclosure is not limited by such examples. Therefore, it should be understood that the examples described above are exemplary in all examples and not restrictive. The scope of the present disclosure should be interpreted by the claims, and all technical ideas within a scope equivalent thereto should be interpreted as being included in the scope of the rights of the present disclosure.

What is claimed:

1. An apparatus of a vehicle, the apparatus comprising:
a communication circuit configured to communicate with a server; and
a processor configured to:
display, via an interface, a target location image transmitted from the server,
receive, via the interface, a user input, wherein the target location image is marked based on the user input to indicate a target location on the target location image, and wherein the target location is associated with a service requested by a terminal of service requester;
generate, based on the user input, a marked target location image,
transmit the marked target location image to the server such that the server shares the marked target location image with the terminal of a service requester,
output, based on the marked target location image, a signal; and
control, based on the signal, driving of the vehicle to the target location.

2. The apparatus of claim 1, wherein the processor is configured to receive a plurality of target location images from the server, and mark, based on the user input, a target location image selected from among the plurality of target location images.

3. The apparatus of claim 1, wherein the processor is configured to:
receive, from the server, a plurality of target location images captured in different directions at one point in time, and
display, via the interface, the plurality of target location images.

4. The apparatus of claim 1, wherein the processor is configured to:
move, based on the user input, a mark displayed on the target location image, and
generate, based on a user input indicating a selection completion after moving the mark, the marked target location image.

5. The apparatus of claim 1, wherein the processor is configured to, based on receiving the marked target location image from the server, display via the interface, the marked target location image.

6. A server configured to communicate with a vehicle, the server comprising:
a communication circuit configured to communicate with a terminal and the vehicle; and
a processor configured to
transmit a target location image to one of the terminal or the vehicle, wherein the target location image corresponds to target location information transmitted from the terminal,
receive a marked target location image, wherein the marked target location image is transmitted from one of the terminal or the vehicle, whichever has received the target location image,
transmit the marked target location image to the other of the terminal or the vehicle,
output, based on the marked target location image, a signal, and
cause the vehicle to control, based on the signal, driving of the vehicle.

7. The server of claim 6, wherein the processor is configured to communicate, based on the target location information, with a neighboring vehicle via the communication circuit, and receive, based on the target location information, the pickup target location image from the neighboring vehicle.

8. The server of claim 7, wherein, based on absence of a neighboring vehicle or not receiving the target location image from the neighboring vehicle, the processor is configured to transmit a pre-stored road view image as the target location image.

9. The server of claim 7, wherein the processor is configured to, based on the target location information and movement path information, communicate with the neighboring vehicle, wherein the neighboring vehicle is expected to pass a target location associated with the target location information, and wherein the movement path information is obtained from the neighboring vehicle.

10. The server of claim 7, wherein the processor is configured to, based on the target location information and movement path information, communicate with a vehicle that has traveled past a target location associated with the target location information, wherein the movement path information is obtained from the neighboring vehicle.

11. The server of claim 7, wherein the marked target location image comprises a marked target location for indicating a target location.

12. The server of claim 6, wherein the processor is configured to:
transmit the target location image to the vehicle, and
transmit the marked target location image transmitted from the vehicle to the terminal.

13. The server of claim 6, wherein the processor is configured to:
transmit the target location image to the terminal and
transmit the marked target location image transmitted from the terminal to the vehicle.

14. The server of claim 6, wherein the processor is configured to transmit a plurality of target location images to one of the terminal or the vehicle.

15. The server of claim 6, wherein the processor is configured to transmit a plurality of target location images to one of the terminal or the vehicle, wherein the plurality of target location images are captured in different directions at one point in time.

16. A method performed by a server configured to communicate with a vehicle, the method comprising:
receiving, from terminal, target location information;
transmitting a target location image to one of the terminal or the vehicle, wherein the target location image corresponds to the target location information;
receiving a marked target location image transmitted from one of the terminal or the vehicle, whichever has received the target location image;
transmitting the marked target location image to the other of the terminal or the vehicle;
outputting, based on the marked target location image, a signal; and
causing, based on the signal, the vehicle to control driving of the vehicle.

17. The method of claim 16, further comprising:
communicating, based on the target location information, with a neighboring vehicle, wherein the target location image is obtained, based on the target location information, from the neighboring vehicle.

18. The method of claim 16, wherein the transmitting the target location image comprises, based on absence of a neighboring vehicle or not receiving the target location image from the neighboring vehicle, transmitting a pre-stored road view image as the target location image.

19. The method of claim 16, further comprising:
based on the target location information and movement path information, communicating with a neighboring vehicle, wherein the neighboring vehicle is expected to pass a target location associated with the target location information, and wherein the movement path information is obtained from the neighboring vehicle.

20. The method of claim 16, further comprising:
based on the target location information and movement path information, communicating with a vehicle that has traveled past a target location associated with the target location information, wherein the movement path information is obtained from a neighboring vehicle.
